(19) United States
(12) Patent Application Publication
(10) Pub. No.: US 2025/0098673 A1
(43) Pub. Date: Mar. 27, 2025

(54) COMPOSITIONS, MEANS AND METHODS FOR A NOVEL INSECT REPELLENT

(71) Applicant: Yosef LOMNICKY, Givat Shmuel (IL)

(72) Inventor: Yosef LOMNICKY, Givat Shmuel (IL)

(21) Appl. No.: 18/968,427

(22) Filed: Dec. 4, 2024

Related U.S. Application Data
(63) Continuation-in-part of application No. 17/625,752, filed on Jan. 9, 2022.

(30) Foreign Application Priority Data
Jul. 9, 2019 (IL) 267941

(51) Int. Cl. A01N 35/02; A01M 1/20; A01M 7/00; A01P 7/04; A01P 17/00

(52) U.S. Cl. CPC A01N 35/02; A01M 1/2022; A01M 7/00; A01P 7/04; A01P 17/00

(57) ABSTRACT

An insect repellent composition for repelling insects from mammals and vegetation. This composition comprises: dihydroxyacetone (DHA) and a carrier suitable for insect repellent compositions. DHA is the active ingredient and the composition is efficacious in repelling insects.

### REFERENCE TO RELATED PUBLICATIONS

This application is a Continuation-in-Part of U.S. patent application Ser. No. 17/625,752, filed Jan. 9, 2022, which is a U.S. National Phase entry under 35 U.S.C. 371 of PCT Pat. Appl. No. PCT/IL2020/050764, filed 8 Jul. 2020, which claims priority from Israel Pat. Appl. No. 267941, filed 9 Jul. 2019. All of these earlier applications are incorporated by reference in their entirety.

### FIELD OF INVENTION

The present invention relates to the field of insect repellency, and a repellent material

### BACKGROUND OF INVENTION

In recent years, there has been an increased interest in insect repellents, due to periodic outbreaks of mosquito-borne diseases, such as the Zika virus, the West-Nile virus and others. The most commonly used insect repellent today is the synthetic compound, DEET (N,N-Diethyl-meta-toluamide). However, DEET may cause skin and eye irritation. DEET also dissolves most plastics, as well as rayon and spandex, and could thus cause damage to clothing, sunglasses, watchstraps and the like. Another minor drawback is its unpleasant odor. Furthermore, there has been some controversy regarding the safety of DEET, and exposure to high doses may induce neurological damage [1-3]. Plant-based insect repellents are generally considered safer; however, they have not been as rigorously tested as DEET and other synthetic insect repellents, and side-effects such as contact dermatitis, as well as more serious neurotoxic effects of many of these natural repellents have been reported [4]. In addition, most of these plant-based insect repellents are quite volatile, and do not provide long-lasting protection (60-180 min.).

In light of the above, there is a need for a long-acting, effective and non-toxic insect repellent.

### SUMMARY OF THE INVENTION

The present invention relates to the field of insect repellency, and more specifically, to a new insect repellent compound.

It is an object of this invention to provide an insect repellent composition for repelling insects from mammals and vegetation, comprising: dihydroxyacetone (DHA) and a carrier suitable for insect repellent compositions, with DHA as the active ingredient.

It is another object of this invention to provide an insect repellent composition for repelling insects from mammals, wherein the mammals are humans or animals.

It is also an object of this invention to provide an insect repellent composition for repelling insects from vegetation, wherein said plants are tobacco, cannabis, or organically grown fruits and vegetables for human and animal consumption.

It is also an object of this invention to provide an insect repellent composition, wherein the concentration of DHA is in the range of 0.5% to 50% (% weight).

It is another object of this invention to provide an insect repellent composition for insect repellency, wherein the composition is in a form selected from the group consisting of liquid, aerosol, lotion, cream, gel, foam, shampoo, solid and any combination thereof.

It is another object of this invention to provide an insect repellent composition, wherein the composition is suitable for topical use.

It is a further object of this invention to provide an insect repellent composition, wherein the composition is suitable for spatial use.

It is another object of this invention to provide a composition for insect repellency wherein the insects to be repelled are selected from the group consisting of: mosquitos, fleas, ants, sand flies, spiders, aphids, tobacco moths and head-lice.

It is also an object of this invention to provide an insect repellent composition, wherein the composition additionally comprises at least one compound selected from the group consisting of water, ethanol, emulsifiers, preservatives, emollients, humectants, oils, surfactants, waxes, solvents, rheology modifiers, suspending agents, thickeners, oils, buffering agents, chelating agents, pH adjusters, chelates, perfumes, brighteners, and any combination thereof.

It is also an object of this invention to provide a composition for insect repellency, wherein the composition further comprises a Maillard reaction inhibitor, selected from the group consisting of aminoguanidine, amphotericin B, plant polyphenols, pyridoxamine, carnosine, thiamine pyrophosphate, niacin, and any combination thereof.

It is another object of this invention to provide a composition for insect repellency formulated for application on clothing, hats, curtains, nets, bed-sheets, wipes, adhesive patches, hair bows, hairpins, jewelry or baby bracelets.

It is also an object of this invention to provide a composition for insect repellency, wherein the composition is suitable for application to adults, children or babies.

It is a further object of this invention to provide a composition for insect repellency, wherein the composition is in a form of immediate release or slow release, or a combination thereof.

It is also an object of this invention to provide a slow release composition for insect repellency, wherein the slow release composition comprises bifunctional DHA esters with short-chain carboxylic acids, and said esters are hydrolysable to form DHA.

It is a further object of this invention to provide bifunctional DHA esters wherein the short chain carboxylic acids have a carbon backbone of 4 to 12 carbon atoms.

It is also an object of this invention to provide bifunctional DHA esters for insect repellency, wherein the repelling effect of DHA and the short-chain carboxylic acids combination is a synergetic effect.

It is a further object of this invention to provide a composition for slow release insect repellents, wherein the slow release formulation comprises DHA incorporation in a polymeric matrix.

It is also an object of this invention to provide a composition for slow release insect repellents, wherein the slow release formulation comprises micro-encapsulation of DHA.

It is also an object of this invention to provide a composition for slow release insect repellents, wherein the slow release formulation comprises DHA incorporated into liposomes.

It is another object of this invention to provide a DHA insect repellent composition, wherein the composition further comprises at least one additional insect repellent, selected from the group consisting of menthol, geraniol, thyme oil, lemongrass oil, rosemary oil, jasmine oil, lemon eucalyptus and citronella extracts, and any combination thereof.

It is another object of this invention to provide a DHA insect repellent composition, wherein the composition further comprises at least one insect bite soother, selected from the group consisting of Aloe Vera, tea tree essential oil, peppermint extract, apple cider vinegar, or any combination thereof.

It is another object of this invention to provide a DHA insect repellent composition, wherein the composition further comprises at least one additional pesticide, selected from the group consisting of azadirachin, pyrethrins, neem oil, fatty acid potassium salts.

It is also an object of this invention to provide a method of repelling insects, consisting of an insect repellent composition, and application of the composition to a subject, thereby repelling insects.

It is a further object of this invention to provide a kit useful for repelling insects, comprising of a vaporizer, an insect repellent composition and instructions for use.

It is also an object of this invention to provide a kit useful for insect repellency, wherein the insect repellent composition is liquid.

It is also an object of this invention to provide a kit useful for insect repellency, wherein the insect repellent composition is solid.

It is another object of this invention to provide a kit useful for insect repellency, wherein the vaporizer is a plug-in electrical device.

It is another object of this invention to provide a kit useful for insect repellency, wherein the vaporizer is a spraying device.

It is also an object of this invention to provide a kit useful for insect repellency, wherein the vaporizer is a coil.

It is a further object of this invention to provide an insect repellent composition for repelling insects from mammals and vegetation, comprising: a dihydroxyacetone (DHA) derivative and a carrier suitable for insect repellent compositions, wherein the DHA derivative is the active ingredient.

It is further object of this invention to disclose an insect repellent composition as described in any of the preceding, wherein the concentration of DHA is in the range of 0.1% to 20% (% wt).

It is further object of this invention to disclose an insect repellent composition as described in any of the preceding, wherein said composition is in a form selected from the group consisting of powder, liquid, aerosol, lotion, cream, gel, foam, shampoo, solid and any combination thereof.

It is further object of this invention to disclose an insect repellent composition as described in any of the preceding, wherein the insects to be repelled are selected from the group consisting of mosquitos, fleas, ants, sand flies, spiders, aphids, tobacco moths, leaf aphid, bed bugs, head-lice, whitefly, thrips and mites.

It is further object of this invention to disclose an insect repellent composition as described in any of the preceding, wherein said composition is formulated for application on plants, trees, or any part of plant or tree, selected from the group consisting of leaves, stalks, flowers, petals, tree trunks, fruits and any combination thereof.

It is further object of this invention to disclose an insect repellent composition as described in any of the preceding, wherein said composition is in a spray form.

It is further object of this invention to disclose an insect repellent composition as described in any of the preceding, wherein the composition additionally comprises emulsifiers/surfactants, wherein said emulsifiers/surfactants comprises at least one compound selected from the group of Nonylphenol Ethoxylate (NPE), Octylphenol Ethoxylate, Alkyl Polyglucoside (APG), Polyethylene Glycol (PEG 400), Span 80 (Sorbitan Monooleate), Tween 20 (Polysorbate 20), Tween 80 (Polysorbate 80), Alkylaryl polyether alcohol or any combination thereof.

It is further object of this invention to disclose an insect repellent composition as described in any of the preceding, the composition further comprising at least one additional pesticide, selected from the group consisting of azadirachin, pyrethrins, fatty acid potassium salts, sulfor, acetamiprid, spirotetramat, spinosad, and any combination thereof.

It is further object of this invention to disclose an insect repellent composition as described in any of the preceding, wherein the composition additionally comprises oils, where said oils comprises at least one compound selected from the group of mineral oil, or silicone oil.

It is another object of this invention to provide a kit useful for insect repellency, wherein the composition is liquid, semi solid or solid.

### BRIEF DESCRIPTION OF THE DRAWINGS

The accompanying drawings, which is included to provide a further understanding of the invention, and are incorporated in, and constitute a part of this specification, illustrate embodiments of the invention and together with the description serve to explain the principles of the invention

FIG. 1 presents a graph comparing the repellency of control, 20% DHA, and commercially available insect repellent (Sano) with a composition of 20% of citrepel 75 dissolved in water, against the common mosquito, Culex quinquefasciatus. Data are presented as mean±SEM.

FIG. 2 presents a graph illustrating the repellency of DHA effect against spotted spider mites in strawberry: Average number of mites at T-0. At the preliminary assessment (T-0), performed the day of application A, the average number of mites per leaves was comparable in all plots, ranging from 0.73 to 1.32.

FIG. 3 presents a graph illustrating the repellency of DHA against spotted spider mites in strawberry: Average number of mites (Day 3 following First application of treatments, A, 3DA-A).

FIG. 4 presents a graph illustrating the repellency of DHA effect against spotted spider mites in strawberry: Efficacy Percentage (%)-A A on Day 3 following First application of treatments, 3DA-A).

FIG. 5 presents a graph illustrating the repellency of DHA effect against spotted spider mites in strawberry: Efficacy Percentage (%) Day 7 following First application of treatments, A, 7DA-A).

FIG. 6 presents a graph illustrating the repellency of DHA effect against spotted spider mites in strawberry Efficacy Percentage (%) at Day 4 following Second application of treatments, 4 DA-B.

FIG. 7 presents a graph illustrating the Repellency of DHA effect against spotted spider mites in strawberry Efficacy percentage %, Day 7 following Second application of treatments, B, 7 DA-B.

FIG. 8 presents a graph illustrating the repellency of DHA effect against spotted spider mites in strawberry: Efficacy percentage %, Day 3 following Third application of treatments, C, 3 DA-C.

FIG. 9 presents a graph illustrating the repellency of DHA effect against spotted spider mites in strawberry: Efficacy percentage %, Day 6 following Third application of treatments, 6 DA-C.

FIG. 10 presents a graph illustrating the repellency of DHA effect against spotted spider mites in strawberry: Efficacy percentage %, Day 14 following Third application of treatments, 14 DA-C.

FIG. 11 presents a graph illustrating the Repellency of DHA effect against spotted spider mites in strawberry: Efficacy percentage % Day 21 following Third application of treatments, 21 DA-C.

### DETAILED DESCRIPTION OF THE INVENTION

The present invention discloses a compound used for providing protection against insect bites; in particular, mosquitos, fleas, ants, sand flies, spiders and head-lice, as well as acting as an insect repellent against aphids tobacco moths, leaf aphid, bed bugs, whitefly, thrips and mites. The inventors have surprisingly found that dihydroxyacetone (DHA), is active as an insect repellent. Protection against insects is thus provided by dihydroxyacetone (DHA), in various compositions. Methods for insect repellency include both topical and spatial compositions.

As used hereinafter, the term “repellent” refers to preventing biting by insects or insects' effects.

As used hereinafter, the term “topical” refers to compositions applied directly to the skin or plant.

As used hereinafter, the term “spatial repellents” refers to chemicals which are released into the air of the treated space, resulting in the prevention or reduction of insect biting or insect effect.

As used hereinafter, the term “insect” refers to, but not limited to mosquitos, fleas, ants, sand flies, and spiders, aphids, tobacco moths head-lice, leaf aphid, bed bugs, whitefly, thrips and mites.

As used hereinafter, the term red spider mite or two-spotted spider mite (Tetranychus urticae) refers to a species of plant-feeding mite generally considered to be a pest. It is the most widely known member of the family Tetranychidae or spider mites.

As used hereinafter, the term whitefly refers to a common pest of plants, particularly greenhouse plants, and a vector of several plant diseases. Whiteflies are hemipterans (Hemiptera is an order of insects, commonly called true bugs) that typically feed on the undersides of plant leaves

As used hereinafter, the term Thrips (also known as thunder flies), an order of insects, the Thysanoptera, refers to minute (mostly 1 mm (0.039 in) long or less), slender insects with fringed wings and unique asymmetrical mouthparts. Thrips can cause damage during feeding. For example, Thrips tabaci, Tabaci thrips, (Frankliniella occidentalis, Thripidae family), are significant pests in vegetable growing due to their destructive feeding habits and ability to transmit plant diseases. Tabaci thrips primarily attack crop such as Cabage, onion, tomatoes, peppers, potatoes, tobacco, cotton, cucumbers, and beans. The economic impact stems from both direct damage to plants and indirect effects through disease transmission.

As used hereinafter, the term Aphids (or greenfly and blackfly) refers to small sap-sucking insects and members of the superfamily Aphidoidea. Aphids are among the most destructive insect pests on cultivated plants in temperate regions. In addition to weakening the plant by sucking sap, they act as vectors for plant viruses and disfigure ornamental plants with deposits of honeydew and the subsequent growth of sooty moulds.

As used hereinafter, the term “Dihydroxyacetone” (DHA) refers to the following compound:

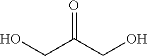

An earlier attempt to provide long-lasting insect repellants was reported by Quintana et al (U.S. Pat. No. 3,668,226). Mono-esters of dihydroxyacetone (DHA) with lower aliphatic carboxylic acids, exhibited long-lasting insect repellent activity. However, the insect repelling effect was attributed to the aliphatic carboxylic acids, while the DHA moiety was utilized as a dermal anchoring moiety, thus providing the longer-lasting insect repelling effect of these aliphatic carboxylic acids.

Dihydroxyacetone (DHA) itself, has been used for many years in the cosmetics industry, as the active ingredient of sunless-tanning products and has been approved by the FDA as a cosmetic ingredient since 1977. The skin-browning effect is a result of a Maillard reaction between DHA and the amino acids of keratin, the major component of the skin surface. This effect fades after 3-10 days following application, in the course of mechanical abrasion or natural exfoliation of the skin. DHA is not systemically absorbed, is non-toxic, and its phosphate ester (DHAP) is involved in many metabolic pathways, such as glycolysis and the Calvin cycle. In response to concern regarding the safety of DHA application to skin, a report by the European Commissions' Scientific Committee on Consumer Safety (SCCS), issued in 2010, concluded that DHA sprays, in concentrations of up to 10%, are safe to use. DHA was also found to be non-irritant, non-carcinogenic and did not cause skin sensitization or photo sensitization effects (4).

Topical formations of insect repellents include creams, ointments, gels and sprays. Another method for topical formulations include alcohol-based foams (U.S. Pat. No. 7,683,018 B2, to Koivisto et al.; US patent 20130165530 A1, to Hillman et al). The use of wipes containing insect repellents is another method for topical application of insect repellents, such as reported by Fellows (WO 1989003639 A1) and Glass (AU patent 2009100380 A4). Additional methods for topical application of insect repellents include adhesive patches, insect repellent-containing bracelets and jewelry, as shown, for example by Quin, (US patent 20130095162 A1). Bracelets containing insect repellent formulations suitable for use by babies and toddlers are also marketed. Insect repellent collars for dogs and horses provide another means for insect repellency (US patent 20120315317 A1)

Another factor to consider when formulating the product is the vaporization rate of the compound. The insect repellent must evaporate from the skin in order to work. High evaporation rates lead to short-term repellency, such as the case with many plant-based repellents. Slow release formulations provide prolonged action of the repellent, as well as reduce toxicity due to lower concentrations of the active ingredient on the skin. For example, a mixture of short-chain carboxylic acids (mainly C₈ and C₉), with different degrees of volatility has been reported to possess long-term insect repellency (U.S. Pat. No. 6,444,216). Esters of such insect repellent compounds necessitate hydrolysis prior to release of the active compound, thereby providing a long-lasting effect. DHA esters of such compounds provide a synergistic effect, due to the repellent effect of both components.

Examples of slow release formulations include micro-encapsulation in synthetic and natural polymers, an example of which is the slow release of DHA enclosed in a dimer form in a watertight composition which releases the DHA when applied (U.S. Pat. No. 5,458,872 A). Other slow release formulations include solid lipid micro and nano particles, liposomes, and complexation with cyclodextrines (Tavares et al., 2018).

Slow release formulations of DHA may also be used for the coating of fabrics, such as nets, bed-sheets, etc. Slow release formulations are more effective for fabrics, since most insect repellents are volatile, and do not provide long-lasting protection.

In general, spatial repellent compounds are highly volatile and capable of diffusing through the air in treated regions. The volatilization of these compounds creates repellent vapors that deter insects. Methods used for spatial insect repellency include the use of plugged in devices, which heat and vaporize the insect repellent, burning candles, such as citronella candles, burning coils containing insect repellents, and the use of an electrostatic spraying device for insect repellents has been reported by Hadingham et al (WO 2012096117 A1)

Liquid formulations of DHA may include additives commonly used in cosmetics, such as emulsifiers, dispersing agents, and film-forming agents. Examples of emulsifiers and dispersing agents usable in the present invention include soap (stearic acid), ethoxylated fatty alcohols, PEG esters of fatty acids. Examples of film forming agents include nitrocellulose and acetylcellulose. Additional suitable formulations include creams, lotions, gels, foams and sprays, with additives commonly used in such cosmetic formulations.

As used hereinafter, the term Plant based insecticides refers to products which have proven effective against plant diseases and pests, but they do not destroy the environment, and fruits and vegetables grown with them are safe to eat.

As we become more aware of the hazardous nature of synthetic chemicals, farmers are turning to eco-friendly alternatives to protect their plants. To avoid harm to humans, pets, and wildlife, use of natural pesticides is recommended.

Insecticides intended for organic growth—such as Neem oil, Sulphur, Spinosad, vinegar, pyrethrins, can help to protect a wide variety of crops without having a detrimental effect on garden ecosystems and the wider environment. substances such as neem oil and Azadirachtin swiftly break down without leaving harmful residues in the plant, soil and water are also biodegradable. This makes neem oil a superior and eco-friendly choice for conscious growers who would rather forgo chemical agents that may leave residuals in the plant and fruits, pollute the soil and harm beneficial organisms. Spinosad is an insecticide based on chemical compounds found in the bacterial species Saccharopolyspora spinosa. Spinosad is a novel mode-of-action insecticide derived from a family of natural products obtained by fermentation of S. spinosa.

Essential oil extracts contain natural compounds that can inhibit plant growth or even kill plants. Some commonly used essential oils with herbicidal properties include clove, orange, cinnamon, lemongrass, and pine oils.)

The active compounds in these oils, such as eugenol, cinnamaldehyde, and citronellal, can disrupt plant cell membranes, interfere with photosynthesis, and cause desiccation).

Neem oil belongs to natural insecticidal oils and affects organisms at the genetic level. It is made from the seeds of the Neem tree and is the active ingredient in many garden products.

It contains Azadirachtin, which has a versatile destructive effect on insects. Firstly, it is an effective repellent. Secondly, it disrupts the feeding and digestive processes in the body of pests. Thirdly, it slows down their growth and development, inhibiting hormonal processes and laying eggs.

As used hereinafter, the term Azadirachtin is similar to Neem oil in that it is derived from the seeds of the neem tree (Azadirachta indica). Initially found to inhibit desert locust feeding, Azadirachtin is now known to affect a broad spectrum of over 200 insect species including aphids, mealybugs, caterpillars, Japanese beetle, whiteflies, mites, root aphids and thrips. Azadirachtin's primary mode of action is as an anti-feedant, but it also disrupts normal insect growth/molting, repels larvae and adults, sterilizes adults and deters egg laying.

Azadirachtin products are preferred by some due to their compatibility with a wide range of Insecticides and Biocontrols, such as the beneficial fungus Beauveria bassiana. With no re-entry restrictions Azadirachtin allows for use in a variety of settings and breaks down rapidly after application, minimizing unwanted effects on the environment. Alternating Azadirachtin applications with other insecticides provides variable control with less risk of insects developing resistance.

Examples of Plant Extracts that have Insecticidal Effects:

### Mint, Thyme, Marigold, Goldenrod, Broccoli Mustard

Pyrethrin is an insecticide derived from the dried flower heads of the Chrysanthemum plant and has been used as an insecticide for more than 60 years. Pyrethrin can be used indoors and outdoors to control insects on many vegetables and fruits.

Parafinic Oil is a fine horticultural oil that is more effective than most horticultural oils. It can be used year-round on woody ornamentals, palms, citrus, apples, avocados, mangos, roses, ivy and many listed vegetables.

As used hereinafter, the term wettable or dusting sulfur refers to a composition containing 90% Sulfur. It controls rust, powdery mildew, brown rot, leaf spots, mites and chiggers. It can be used on mangos, peaches, strawberries, flowers, shrubs, lawns and many other listed vegetables. The following examples are representative of some formulations that may be based on the above disclosure. Those skilled in the art will recognize other various formulations and materials that are effective in achieving the invention disclosed herein.

### Example 1

In an embodiment of this invention, the insect repellent effect of a 20% DHA solution was studied. These studies were carried out at Poseidon Sciences Insect Control Laboratory (Miagao, Iloilo, Philippines), a breeding facility for C. quinquefasciatus, for research and development. The insect repellency of a DHA solution, comprising 20% DHA dissolved in a 30% ethanol aqueous solution, was compared to that of a Placebo solution, comprising 30% ethanol in water, as a negative control solution. As a positive control, the repellency of DHA was also compared to that of a commercial Sano insect repellent, a plant based repellent, using a composition of 20% of citrepel 75 dissolved in water. The placebo and the 20% DHA solution were kept in a refrigerator until the day of use. The samples were removed from the refrigerator and kept at room temperature for 3 hours before the tests were undertaken.

The above-mentioned solutions were then tested on a total of 10 subjects (age 19 to 44 comprising a total of 6 women and 4 men), all in good health. Each subject had signed an Informed Consent Form. This study had been approved by Poseidon Sciences IRB (Institutional Review Board).

The study group included 3 women and two men subjects. The Control Group included 3 women and 2 men subjects who received placebo treatment.

All studies were conducted starting at 4:00 PM and all human subjects did not consume any food for a period of at least 2 hours prior to the repellent test. All subjects did not use any cosmetic product for at least 24 hours prior to the tests. Four drops of the DHA solution or placebo solution were applied on the exposed forearm and immediately spread over the exposed skin with a gloved finger. As requested, a period of 1 minute was allowed to lapse before insertion of the forearm inside the cage. The study was conducted at room temperature (27° C. to 29° C.) under ambient light conditions.

Following application of the tested solution to the arm of the subject, testing was carried out as follows: a research scientist recorded the time of insertion of the arm into the cage and observed mosquito landing. The subject indicated that a confirmed bite had occurred and the investigator confirmed by visual examination of the forearm. This was further reconfirmed by a second bite before terminating the study. The Protection Time, defined in this study as the period that had elapsed from the insertion of the arm into the cage and the time for the first confirmed bite (indicating that the tested product had reached its limit of protection from mosquitoes), was recorded for each subject. Results are shown in Table 1 below, presented for each subject, as well as the mean±SD and SEM for each group.

TABLE 1
Repellent effects of placebo, 20% DHA, and Sano repellent,
against the mosquito Culex quinquefasciatus,

| Product | Protection Time (minutes) | | | | | | | |
|---|---|---|---|---|---|---|---|---|
| Name | Subject 1 | Subject 2 | Subject 3 | Subject 4 | Subject 5 | Mean | SD | SEM |
| Placebo | 0.17 | 0.13 | 0.17 | 0.12 | 0.20 | 0.16 | 0.03 | 0.01 |
| 20% | 45 | 50 | 40 | 35 | 56 | 45.2 | 7.36 | 3.35 |
| DHA | | | | | | | | |
| Sano ™ | 45 | 60 | 70 | 50 | 60 | 57.0 | 9.8 | 4.50 |
| Repellent | | | | | | | | |

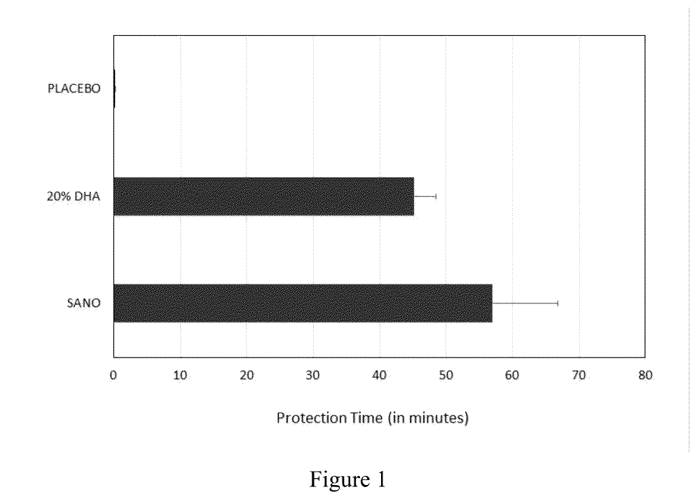

The data obtained from these subjects is also presented in FIG. 1. Data is presented as mean±SEM. Data analysis (using a Student t-test) shows that the repellency of 20% DHA is significantly different from that of the placebo (P<0.0001), but no significant difference between 20% DHA and the commercial Sano product was observed (P<0.064). It should be noted that data from the placebo and 20% DHA were obtained at a different time from the data from the SANO product, and results are presented here as an historical comparison. Thus, the mean protection time found for DHA (45 minutes) is in the range of that of competing natural products (30 minutes-1 hour), tested under the conditions of this bioassay.

### Example 2

In another preferred embodiment of this invention, compositions of DHA are prepared for topical application. DHA compositions according to this invention include creams, ointments, lotions and gels.

A non-limiting example for a composition suitable for a cream, containing 20% DHA is shown in Table 2.

TABLE 2
Composition of a 20% DHA repellent cream

| Ingredient | % of weight |
|---|---|
| Water | 76.5 |
| DHA | 20 |
| Sodium Lauryl Sulfate | 5 |
| Cocamidopropyl betaine | 5 |
| PEG 8 | 1.5 |
| Glycerine | 1 |
| Disodium Lauryl Sulfosuccinate | 1 |

Another non-limiting example for a DHA composition according to this invention includes alco-gels, used for hand and skin sanitization. Table 3 shows a composition suitable for a DHA containing alco-gel.

TABLE 3
Composition of a DHA containing alco-gel

| Ingredient | % of weight |
|---|---|
| Water | 18.7 |
| DHA | 10 |
| Carbomer | 0.24 |
| Glycerine | 0.7 |
| Ethanol | 70 |
| Triisopropanolamine | 0.26 |
| Fragrance | 0.1 |

Additional topical compositions of DHA include inter alia sprays, aerosols and foams. All such compositions are prepared by adding suitable carriers and/or additives which are conventional in cosmetics. A non-limiting example for a formulation of a DHA-containing insect repellent spray is shown in table 4.

TABLE 4
Composition of DHA insect repellent spray

| Ingredient | % weight |
|---|---|
| Water | 50.5 |
| DHA | 15 |
| Ethanol | 25 |
| hexane | 1.5 |
| Polysorbate 80 | 8 |

Topical DHA formulations according to this invention, also include inter alia formulations suitable for babies, such as baby creams, lotions, and baby oils. A non-limiting example for a formulation of DHA-containing baby cream is shown in Table 5.

TABLE 5
Composition of DHA containing baby cream

| Ingredients | % weight |
|---|---|
| Water | 72.8 |
| DHA | 5 |
| Glycerol monostearate | 2.5 |
| Stearic acid | 1.2 |
| Lanolin | 1.0 |
| Technical white oil | 15 |
| Glycerol | 2.5 |
| Triethanolamine | A few drops |

### Example 3

In another preferred embodiment of this invention, slow-release formulations of DHA are used for insect repellency. In one example, slow release is obtained by encapsulation of DHA in microcapsules. Examples of materials used for microencapsulation include, but are not limited to, sodium alginate, gelatin, ethyl cellulose and polyurethane. In another example of a slow release formulation, DHA is encapsulated in solid lipid micro or nanoparticles. Encapsulation of DHA in liposomes, formulated from phospholipids, provides an additional formulation of slow release of DHA.

### Example 4

In another preferred embodiment of this invention, DHA is impregnated into fabrics, such as clothing bed sheets, mosquito netting, curtains, gloves, hats etc. Clothing according to this invention includes out-door clothing, as well as pajamas. Impregnation is carried out using various techniques, such as soaking the fabric in a solution containing DHA, or spraying it onto the fabric, using a DHA spray composition suitable for fabrics. Such DHA compositions may also be used, according to this invention, for application to backpacks, tents, adhesive strips to be applied to clothing, as well as wearable wrist and ankle bracelets.

DHA may also be applied to the fabric as a slow release formulation, comprising encapsulation of DHA in microcapsules, using materials known in the art for microencapsulation, with the microcapsule consisting of natural or synthetic polymers. DHA may also be impregnated in wipes, and adhesive patches, the latter providing a slow release formulation of DHA.

### Example 5

Another preferred embodiment of this invention includes kits for spatial insect repellent release. A kit for spatial release of DHA, according to this invention, includes a plugged-in electrical device, for heating and evaporating DHA. DHA formulations suitable for such devices include tablets and liquid solutions. Liquid solutions contain 0.5-50% DHA, dissolved in hydrocarbon organic solvents. Tablet formulations contain 4-50% DHA (DHA powder or liquid can be used at relatively high concentrations in devices or patches). Another example is a spatial release kit for DHA comprising a spraying device and a dispersion medium for DHA, thereby releasing DHA into the room. Such devices are suitable for indoor use. Spatial devices for outside use include candles and burned coils.

### Example 6

In another embodiment of this invention, inhibitors of the Maillard reaction are added to the DHA topical compositions. Such inhibitors prevent the skin-coloring effect of DHA. These inhibitors include amino-guanidine and amphoterin B, as well as naturally occurring compounds such as plant polyphenols, pyridoxamine (a vitamin B₆ derivative), carnosine (an anti-oxidant), thiamine pyrophosphate (a vitamin B₁ derivative), and niacin (a form of vitamin B₃).

### Example 7

Short-chain carboxylic acids (C₄-C₁₂) have been shown to exhibit insect repellent activity (Reifenrath, in U.S. Pat. No. 6,444,216 B2). The synthesis of DHA monoesters of such carboxylic acids has been reported (Quintana et al, U.S. Pat. No. 3,668,226 A). Following topical application of such DHA monoesters with such short chain carboxylic acids, these esters then react with agents found on the skin, resulting in the gradual release of DHA and the short-chain carboxylic acids. Since both components exhibit insect repellent activity, a synergistic effect is obtained. Other derivatives of DHA, include di-substituted derivatives, of the general formula:

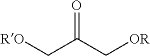

where R and R″ are short chain carboxylic acids, with a C₄-C₁₂ carbon backbone, and may be the same or different. Hydrolysis of these compounds following topical application, results in the release of DHA and these short-chain carboxylic acids, resulting in a synergetic effect.

### Example 8

In another embodiment of this invention, DHA is combined with other insect repellents. Such combinations have been shown to be more effective than each component alone. These additional insect repellents may be plant based insect repellents, such as menthol, geraniol, thyme oil, lemongrass oil, rosemary oil jasmine, and citronella extracts. DHA may be combined with one or more of these natural repellents. In these compositions, DHA may be used in concentrations of 5%-50%, and the plant based components in concentrations of 0.5%-50%. These combinations are used with suitable formulations. DHA may also be used in combination with low concentrations of DEET, thus avoiding side effects of DEET when used in high concentrations. Combinations of DHA with DEET include DHA in concentrations of 0.5%-50%, and DEET in concentrations of 1%-10%, in a suitable formulation. DHA may also be used in combination with other components used for relief from itchiness caused by insect bites. Such components include, but are not limited to aloe Vera, tea tree essential oil, peppermint extract and apple cider vinegar.

### Example 9

In another preferred embodiment of this invention, DHA is used for repelling insects from plants. The insects repelled by DHA include aphids and tobacco moths. DHA can be used in concentrations of 0.5%-50%. DHA may be also used in combination with additional plant based and EPA (Environmental Protection Agency)-approved pesticides. Such pesticides include azadirachtin, pyrethrins, Neem oil, and fatty acid potassium salts. These additional pesticides are used in concentrations of 0.1%-1.0%.

### Example 10

In another preferred embodiment of this invention, DHA is used in lice repellent compositions. Alcohols, such as isopropyl alcohol, have been shown to be effective anti-lice agents (GB 1,604,857; EP 0262885). DHA may be used in concentrations of 5%-20%. A non-limiting example for formulation of a DHA-containing lice repellent hairspray is shown in Table 6.

TABLE 6
Composition of DHA lice repellent hairspray

| Ingredient | % weight |
|---|---|
| Polyvinypyrrolidone/acrylate copolymer | 5 |
| Aminomethylpropanol (AMP) | 0.23 |
| DHA | 5 |
| Pyridoxamine | 5 |
| Propane/Butane 25:75 | 50 |
| Perfume | qs (as needed) |
| Ethanol (abs.) | Balance |

### Example 11

In another preferred embodiment of this invention, DHA is shown to have repellent efficacy against whitefly in cauliflower and cucumber.

### Overview

Whitefly (Bemisia tabaci), is a major pest, in many crops around the world. These pests are carriers of several virus diseases and are damaging the leaves and fruit with scratches and punch-and-suck activity. Furthermore, in cauliflower, excreting honeydew on the leaves and fruit, causes to mold development, which can disqualify the products for the market.

### Formulation—DHA in Aqueous Formulation

### Study 1

### Pest Control Experiment in Cauliflower Compared to Mospilan (Contains 20% Acetamiprid), Israel:

### Objective

Assessment of Dihydroxyacetone product (DHA) effect on Whitefly in cauliflower, compared to commercial Mospilan

### Methods and Treatments

DHA was sprayed in two doses on cauliflower, for checking the effect on Whiteflies. These treatments were tested vs. a standard treatment (Mospilan) and a control treatment (not spraying):
DHA, 2.5% (aqueous solution)
DHA, 5% (aqueous solution)
Mospilan (Acetamiprid 200 g/L), 500 ml per hectare
Control (water spraying)

The experiment was implemented with 4 replicates for each treatment (randomly spread). Each replicate was 12 m long and 2 m width. Spraying volume was 40 L/Dunam. The solution for spraying was in a volume of 4 L.

Counting and statistics: Counting Whiteflies and Thrips was made on 20 leaves, selected randomly in each replicate. Variance analysis was made by Tukey-Kramer (α=0.05). Counting was performed every 7 days.

### Results of Study 1

TABLE 7
Average no. of Whiteflies on a leaf, before annlication (zero count).

| | Mature | Young stage |
|---|---|---|
| Treatment | Whiteflies | Whiteflies |
| DHA 2.5% | 18.3 | 13.7 |
| DHA 5% | 21.8 | 10.5 |
| Mospilan 500 ml/HA | 17.5 | 18.8 |
| Control | 15.2 | 9.4 |

Values with no signs or similar signs in a column are not significantly different (Tukey-Kramer; α = 0.05).

TABLE 8
Average no. of Whiteflies on a leaf. Values with no signs or similar signs in a column
are not significantly different (Tukey-Kramer; a = 0.05).

| | Mature Whiteflies | | | Young stage Whiteflies | | |
|---|---|---|---|---|---|---|
| Treatment | 1^{st} count | 2^{nd} count | 3^{rd} count | 1^{st} count | 2^{nd} count | 3^{rd} count |
| DHA 2.5% | 13.6 | 14.4 | 15.5 b | 12.6 | 65.3 | 101.3 |
| DHA 5% | 27.0 | 25.8 | 16.3 b | 15.8 | 55.1 | 97.0 |
| Mospilan 500 ml/HA | 24.4 | 24.3 | 16.6 b | 33.0 | 33.3 | 86.0 |
| Control | 22.4 | 27.5 | 42.6 a | 15.3 | 59.6 | 141.3 |

### Study 1: Summary and Conclusions

For mature Whitefly a significant reduction of ˜65% compared to control group was observed in adults, and similar effect as the positive control Mospilan. For the young stage Whitefly, a trend of ˜40% reduction was observed

### Study 2: Effect of DHA Formulation in Cauliflower Compared to Spirotetramat 22.4%

### Objectives

Assessment of Dihydroxyacetone product (DHA) effect on Whitefly in cauliflower, compared to commercial Movento (spirotetramat 22.4%).

### Methods and Treatments

DHA was sprayed in 3 doses on cauliflower, for assessing the effect on Whiteflies. These treatments were tested vs. a standard treatment (spirotetramat) and a control treatment (water spraying).
DHA, 2% (aqueous solution)
DHA, 2.5% (aqueous solution)
DHA, 5% (aqueous solution)
Spirotetramat 100 g/L, 500 ml per hectare
Control

The experiment implemented with 4 replicates for each treatment (randomly spread). Each replicate was 12 m long, on one bed. Spraying volume was 300 L/hectare. The solution for spraying was in a volume of 3 L per treatment

Counting Whiteflies on 20 leaves (both mature and young stage), selected randomly in each replicate. Variance analysis was made by Tukey-Kramer (α=0.05).

### Results

TABLE 9
Average no. of mature Whiteflies on a leaf.

| | zero | 1^{st} | 2^{nd} | 3^{rd} |
|---|---|---|---|---|
| | count | count | count | count |
| Treatment | Day 0 | Day 7 | Day 14 | Day 21 |
| DHA 2% | 1.8 | 2.3 | 3.6 ^{a} | 8.8 ^{ab} |
| DHA 2.5% | 1.3 | 2.0 | 2.7 ^{ab} | 4.3 ^{b} |
| DHA 5% | 2.5 | 2.1 | 2.4 ^{ab} | 3.0 ^{b} |
| Spirotetramat 500 | 1.6 | 1.6 | 1.3 ^{b} | 2.8 ^{b} |
| ml/HA | | | | |
| Control | 1.8 | 2.0 | 4.8 ^{a} | 12.5 ^{a} |

Values with no signs nor similar signs in a column are not significantly different (Tukey-Kramer; α = 0.05).

TABLE 10
Average no. of young stages of Whiteflies on a leaf.

| | zero | 1^{st} | 2^{nd} | 3^{rd} |
|---|---|---|---|---|
| | count | count | count | count |
| Treatment | Day 0 | Day 7 | Day 14 | Day 21 |
| DHA 2% | 1.1 | 4.0 | 20.6 ^{ab} | 18.7 |
| DHA 2.5% | 1.5 | 2.4 | 23.3 ^{ab} | 15.0 |
| DHA 5% | 2.6 | 1.2 | 11.0 ^{b} | 13.3 |
| Spirotetramat 500 | 3.5 | 3.1 | 8.8 ^{b} | 20.0 |
| ml/HA | | | | |
| Control | 1.9 | 4.8 | 26.9 ^{a} | 22.2 |

Values with no signs nor similar signs in a column are not significantly different (Tukey-Kramer; α = 0.05).

TABLE 11
Flight intensity around the plants (on a scale of 0-5).

| | zero | 1^{st} | 2^{nd} | 3^{rd} |
|---|---|---|---|---|
| Treatment | count | count | count | count |
| DHA 2% | 0.5 | 0.8 | 0.5 ^{ab} | 1.8 ^{ab} |
| DHA 2.5% | 0.5 | 0.8 | 0.5 ^{ab} | 1.3 ^{ab} |
| DHA 5% | 0.8 | 1.0 | 0.8 ^{ab} | 0.8 ^{b} |
| Spirotetramat 500 | 0.8 | 0.5 | 0.1 ^{b} | 0.5 ^{b} |
| ml/HA | | | | |
| Control | 0.5 | 0.9 | 1.3 ^{a} | 2.8 ^{a} |

Values with no signs nor similar signs in a column are not significantly different (Tukey-Kramer; α = 0.05, with a conversion to arcsin).

DHA was sprayed in 3 doses on cauliflower, for assessing the effect on Whiteflies. These treatments were tested vs. a standard treatment (Spirotetramat) and a control treatment (not spraying). The first counting date was performed 1 week after the first application. The average number of Mature Whiteflies on a leaf ranged between 1.6 to 2.3, with no significant difference between treatments. The average number of young stages per leaf was between 1.2 and 4.0 in the different treatments, also without a significant difference. The flight intensity of Whiteflies was low in all treatments.

In the second counting date, a week after the second application, the number of Whiteflies per leaf went up in the control treatment and reached to 4.8 in average. Still there was not a significant difference in mature Whiteflies levels, between the control treatment and the DHA treatments. Nevertheless, the number of young stages of Whiteflies was significantly higher in the control treatment (26.9 per leaf), than in the 5% solution of DHA treatment (11.0 per leaf, in average).

In the last counting date, 1 week after the 3^{rd} application, there was a sharp rise in the average number of mature Whiteflies in the control treatment (12.5 per leaf), whereas in the spraying treatments of DHA in 2.5% and 5% solution concentrations, there was only a small increase (an average of 4.3 per leaf, for the most). These spraying treatments with DHA were found significantly more efficient, compared with the control treatment.

### Young Stages of Whiteflies:

The flight intensity after 3rd application was found to be significantly higher in the control treatment, compared with the 5% DHA treatment. In the control treatment, the flight intensity was assessed to be in a grade of 2.8 out of maximum 5, and in the 5% DHA treatment it was only 0.8 out of 5 and comparable to Spirotetramat.

### Study 2: Summary and Conclusions

DHA in solution concentrations of 2.5% and 5%, was shown to be effective in the control of mature Whiteflies. It is also effective in a concentration of 5%, in reducing the young stages of Whiteflies and the flying intensity. Furthermore, during the experiment period, there were not any significant differences in the Whitefly levels between the DHA treatments and the treatment with Spirotetramat.

### Study 3

### Pest Control Experiment in Cucumber Compared to Mospilan, Israel:

### Treatments

DHA was sprayed in 2 doses on cucumber plants, for assessing the effect on Whiteflies. These treatments were tested vs a standard treatment (Mospilan) and a control treatment (with water spraying).
DHA, 5% (aqueous)
DHA, 10% (aqueous)
Mospilan (Acetamiprid 200 g/L), 300 ml per hectare
Control

The experiment was implemented with 6 replicates for each treatment (randomly spread). Each replicate was 12 m long, on one bed. Spraying volume was 600 L/hectare. The solution for spraying was in a volume of 6 L per treatment.

Counting whiteflies on 20 leaves (both mature and young stage), selected randomly in each replicate. Variance analysis was made by Tukey-Kramer (α=0.05).

### Results

TABLE 12
Average no. of mature Whiteflies on a leaf.

| | zero | 1^{st} | 2^{nd} | 3^{rd} |
|---|---|---|---|---|
| | count | count | count | count |
| Treatment | Day 0 | Day 4 | Day 8 | Day 11 |
| DHA 5% | 10.3 | 11.7 | 8.1 ^{ab} | 9.6 |
| DHA 10% | 8.1 | 10.3 | 5.5 ^{b} | 8.5 |
| Mospilan 300 cc/HA | 12.2 | 14.5 | 3.9 ^{b} | 7.3 |
| Control | 9.5 | 11.5 | 14.6 ^{a} | 13.8 |

Values with no signs nor similar signs in a column are not significantly different (Tukey-Kramer; α = 0.05).

TABLE 13
Average no. of young stages of Whiteflies on a leaf.

| | zero | 1^{st} | 2^{nd} | 3^{rd} |
|---|---|---|---|---|
| | count | count | count | count |
| Treatment | Day 0 | Day 4 | Day 8 | Day 11 |
| DHA 5% | 9.3 | 8.1 | 6.8 ^{ab} | 5.5 ^{b} |
| DHA 10% | 6.2 | 5.7 | 1.5 ^{b} | 3.1 ^{b} |
| Mospilan 300 cc/HA | 6.5 | 6.9 | 4.3 ^{b} | 6.2 ^{b} |
| Control | 8.0 | 9.7 | 10.2 ^{a} | 14.7 ^{a} |

Values with no signs nor similar signs in a column are not significantly different (Tukey-Kramer; α = 0.05).

### Study 3: Summary and Conclusions

Study 3 revealed that DHA in water solution concentrations of 5% and 10%, was effective in control of Whiteflies in cucumber. During the experiment, there were no significant differences in Whitefly levels between the DHA treatments and the standard Mospilan treatment.

### Example 12

In another preferred embodiment of this invention, DHA is shown to have repellent efficacy against spotted spider mites in strawberry.

### Overview

The trial scheme included six treatments (including the untreated CHECK control group), repeated 5 times (replicates). Each plot was constituted by 8 strawberry potted plants (plot 0.5 m×1 m), naturally infested by two spotted spider mite population.

First application (A) was performed on Day 0, the second (B) on Day 7 (7 DA-A) and the last one (C) on Day 14, (an application interval of 7 days). Each application was performed by a spray method.

During the trial, at each assessment timing, 20 leaves per plot were collected and the number of spider mites was recorded, with the aim to evaluate the efficacy.

Results showed a dose effect of DHA Formulation in each assessment, always comparable with the standard, except for its lowest dose.

### Objectives

The aim of this study was to evaluate the efficacy of 5 dose rates of Dihydroxyacetone containing surfactant (spreader), comparing to label dose rate of the commercial standard product Azadirachtin (OIKOS) 26 g/L, applied on potted strawberry plants, against a natural infestation of the two spotted spider mite (Tetranychus urticae) population

### DHA Formulations

Dihydroxyacetone-DHT in 1-10% (V/V)-
Surfactant −0.05% (V/V).

### Methods and Treatments

### Study Scheme: Experimental Protocol Included the Following Treatments Program:

TABLE 14
Study scheme of DHA effect against spotted spider mites in strawberry

| Trt | | Treatment | Form | | Rate |
|---|---|---|---|---|---|
| No. | Type | Name | Type | Rate | Unit |
| 1 | CHK | Untreated Check | | | |
| | ADJ | Surfactant | L | 0.05 | % V/V |
| 2 | INSE | DHA | GR | 10 | % V/V |
| | ADJ | Surfactant | L | 0.05 | % V/V |
| 3 | INSE | DHA) | GR | 5 | % V/V |
| | ADJ | Surfactant | L | 0.05 | % V/V |
| 4 | INSE | DHA | GR | 2.5 | % V/V |
| | ADJ | Surfactant | L | 0.05 | % V/V |
| 5 | INSE | DHA | GR | 1 | % V/V |
| | ADJ | Surfactant | L | 0.05 | % V/V |
| 6 | INSE | Azadirachtin | EC | 1.5 | L/ha |
| | ADJ | Surfactant | L | 0.05 | % V/V |

All products were spray formulations, applied with an electric backpack sprayer.

In order to obtain a uniform product application on the plants, a spray volume of 500 L/ha was delivered.

An untreated check provided information on natural pest development.
EC—Emulsifiable concentrate
L—Liquid
GR—Granular
L/ha—Liters per hectare
INSE—Insecticide
ADJ—adjuvant

### Plants:

Healthy and untreated plants of strawberry (Fragaria x ananassa) San Andreas variety, were used. The plants were transplanted in pots of 17 cm diameter, transferred and kept in greenhouse condition. Eight plants in 2 row (0.5 m×1 m) represent the experimental plot; each plot was replicated 5 times.

The trial started when a two spotted spider mite population was recorded in each plot.

### Methods:

The trial was performed under greenhouse conditions.

In order to simulate conventional agricultural practices and to ensure a uniform distribution, all tested products were applied by an electric backpack sprayer in the experimental plots. The 3 spray applications were performed with an interval of 7 days; the first was carried out when the spider mites was detected in the experimental field. For untreated check only water, added with the surfactant at 0.05%.

An application volume of 500 L/ha was established for each application.

At each assessment 20 leaves per plot were checked under the stereomicroscope to count and record the number of mites (distinguishing in eggs, nymphs and adults), at 0, TA+3, TA+7, TB+4, TB+7, TC+3, TC+6, TC+14 and TC+20.

After each assessment, an efficacy evaluation was performed.

Data collected during the trial were subjected to analysis of variance ANOVA.

Comparison between the untreated check and each treated plot were made by using HENDERSON-TILTON's formula. Treatment average mean was calculated and compared using the STUDENT-NEWMAN-KEULS separation test (P=0.05). Statistical procedures were applied using the ARM2022 Software.

### Results

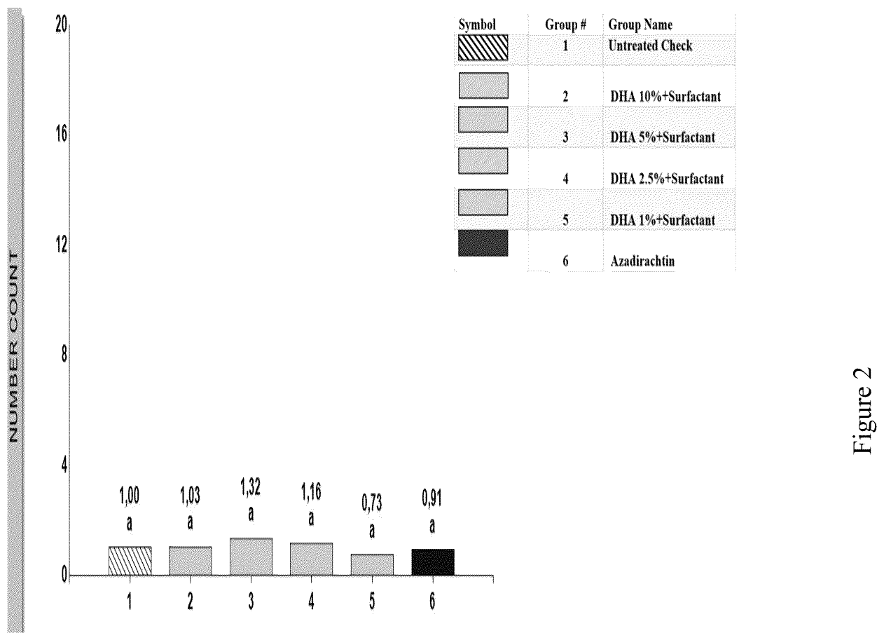

At the preliminary assessment (T-0), performed the day of application A (day 0) the average number of mites per leaves was comparable in all plots, ranging from 0.73 to 1.32. (FIG. 2).

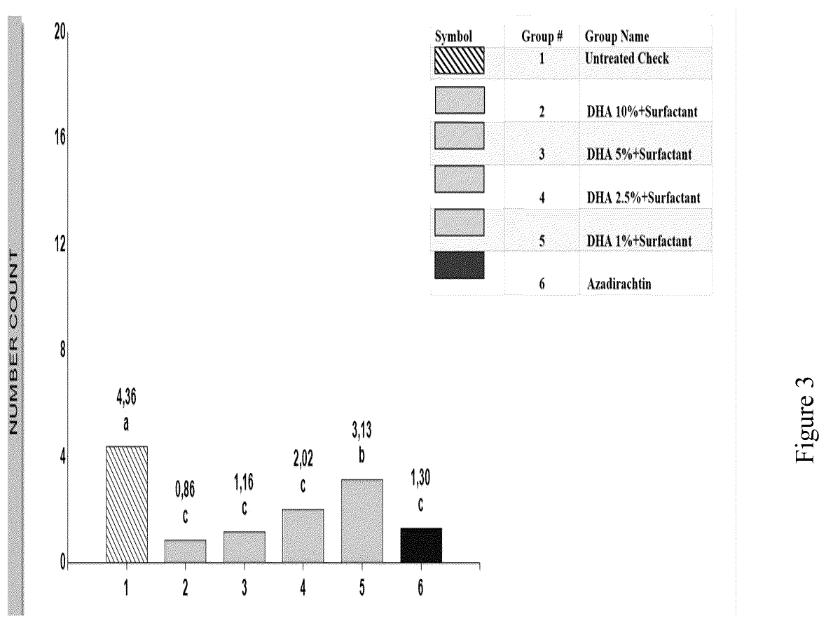

At the 1^{st} efficacy assessment, performed on Day 3 following First application of treatments, A, (3 DA-A), the average number of mites per leaves was increased (from 0.86 to 4.36), excepted in treatments number 2 and 3. A statistically significant difference between untreated check and the other treatments was recorded. DHA formulations at all dose rates were comparable with Azadirachtin, excluding treatment number 5, the lowest dose. (FIG. 3).

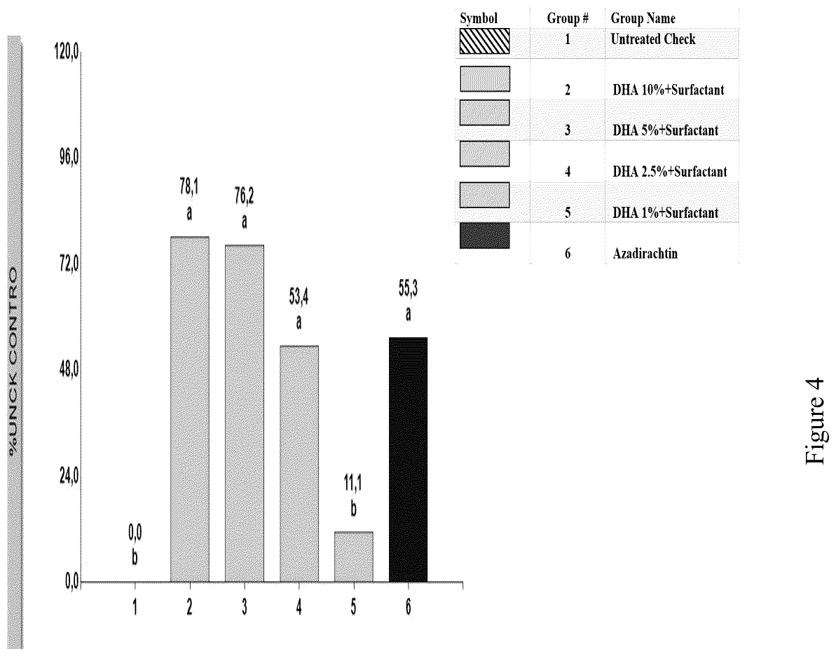

At this assessment, a statistically significant difference between untreated CHECK and the other treatments was recorded. DHA-1 formulations are comparable with Azadirachtin, excluding the lowest dose (treatment number 5). Efficacy Percentage (%)-A on Day 3 following First application of treatments (3DA-A) FIG. 4).

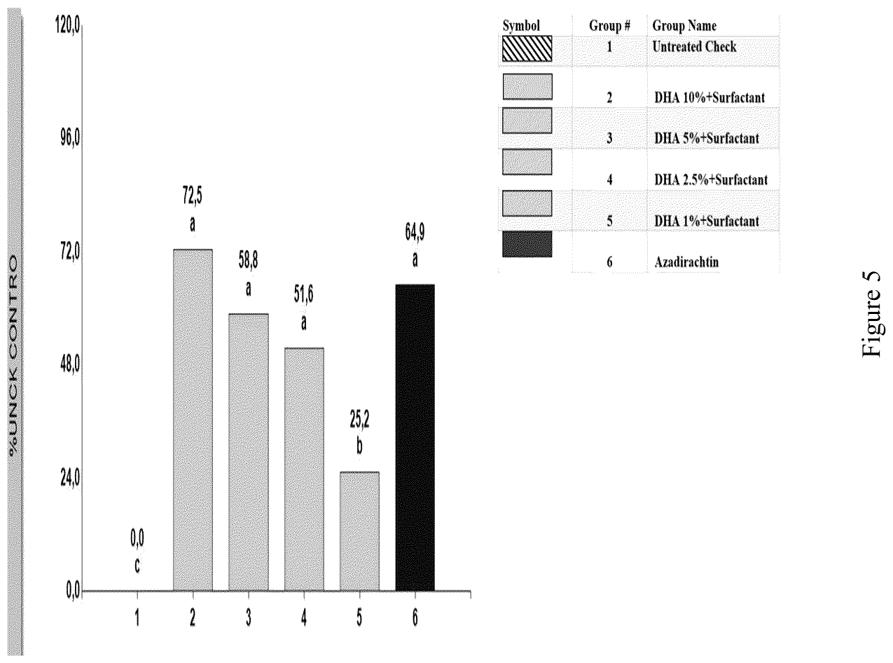

At 7 DA-A (2^{nd} efficacy assessment), performed on Day 7, a statistically significant difference percentage efficacy % between the untreated control and all treatments was recorded. DHA formulations are comparable with the standard Azadirachtin, except for treatment number 5. Efficacy Percentage (%) Day 7 following First application of treatments, A (7DA-A; FIG. 5.

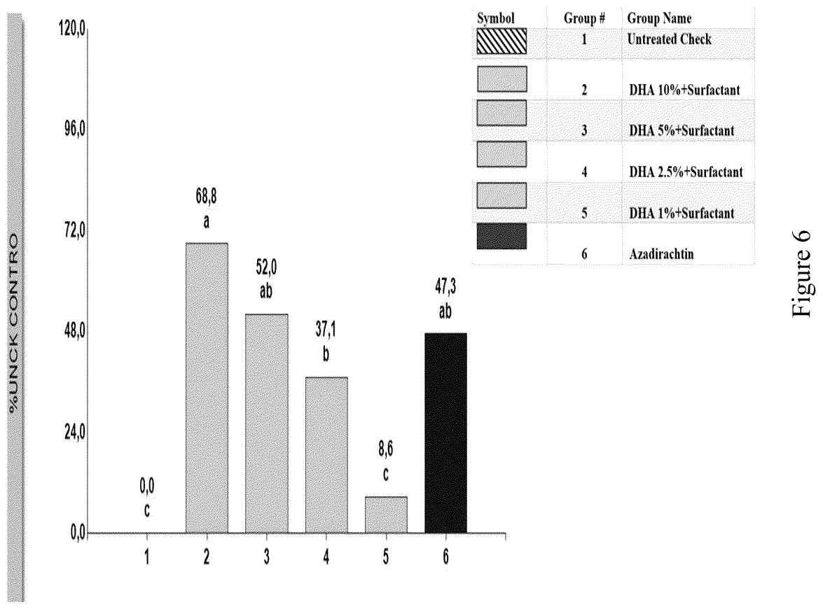

At 4 DA-B (3^{rd} efficacy assessment), a statistically significant difference on efficacy % between the untreated control and all treated plots was detected, except for the lowest DHA formulation rate (treatment number 5). DHA formulation highest dose rate showed the best performance, even without statistically significant difference with Azadirachtin. Efficacy Percentage (%) at Day 4 following Second application of treatments (4 DA-B; FIG. 6).

At 4^{th} efficacy assessment (7 DA-B), performed on Day 7 following Second application of treatments, the untreated control was comparable to treatment number 5. No statistically significant differences were recorded among the other treated plots.

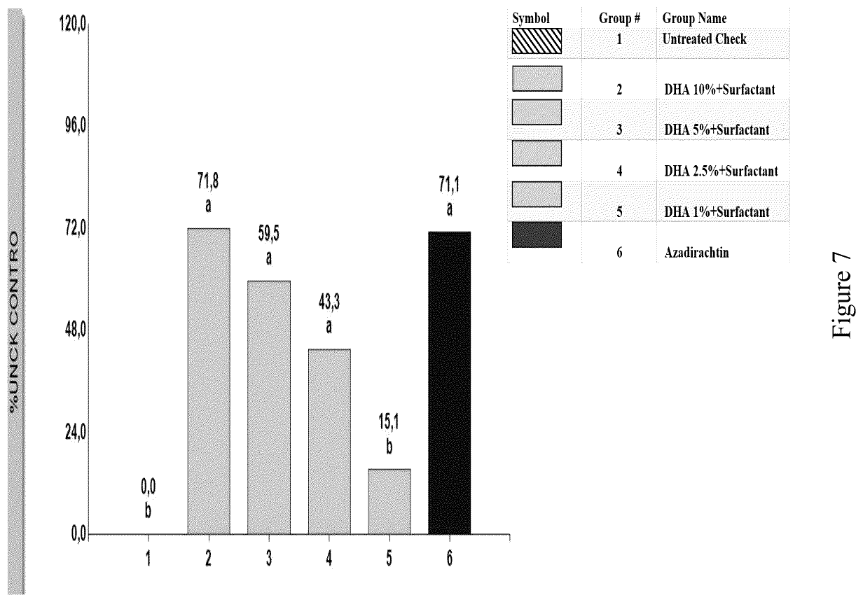

Treatment 2, 3 and 4 were statistically comparable with the standard product. Efficacy percentage %, Day 7 following Second application of treatments, B (7 DA-B; FIG. 7).

The 5^{th} efficacy assessment (3 DA-C) was performed on Day 3 following Third application of treatments, the untreated control was comparable to treatment number 5. No statistically significant differences were recorded among the other treated plots.

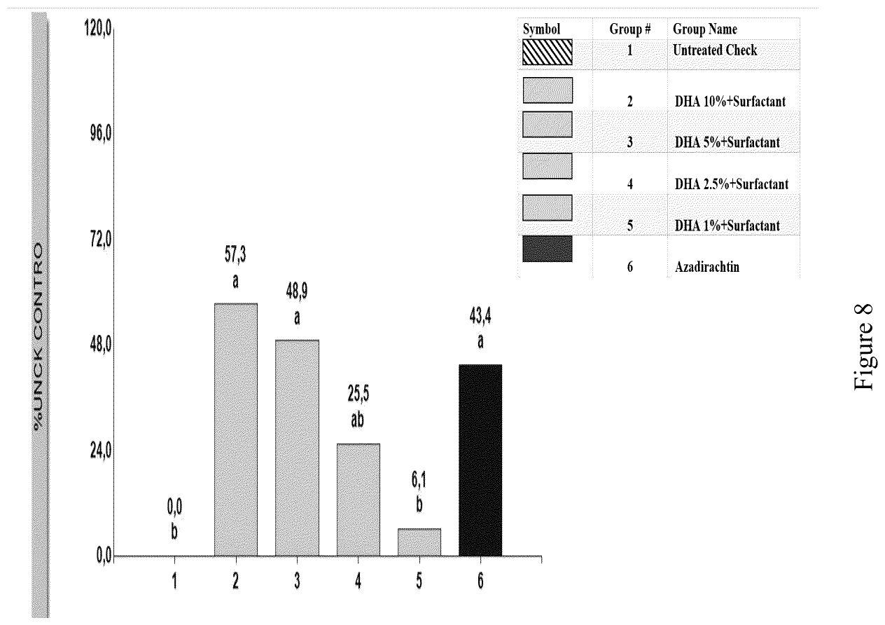

Treatment 2, 3 and 4 were statistically comparable with the standard product Azadirachtin. Efficacy percentage %, Day 3 following Third application of treatments, C (3 DA-C; FIG. 8).

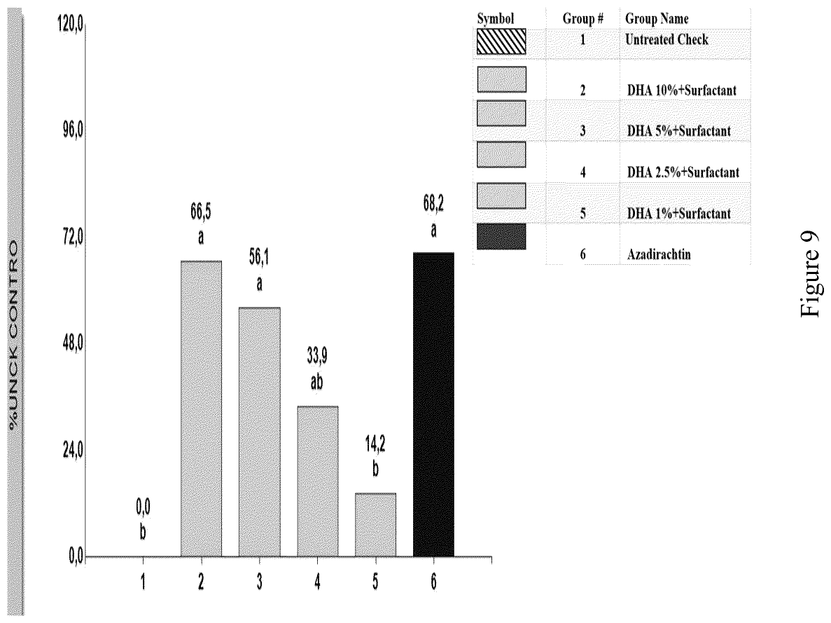

The 6^{th} efficacy assessment (6 DA-C), performed on Day 6 following Third application of treatments, the efficacy graph showed the same statistically significant differences detected in the previous assessment. Efficacy percentage %, Day 6 following Third application of treatments (6 DA-C; FIG. 9).

The 7^{th} efficacy assessment (14 DA-C), performed on Day 14 following Third application of treatments, the efficacy graph showed a constant trend among the treatments, although there was a general efficacy reduction.

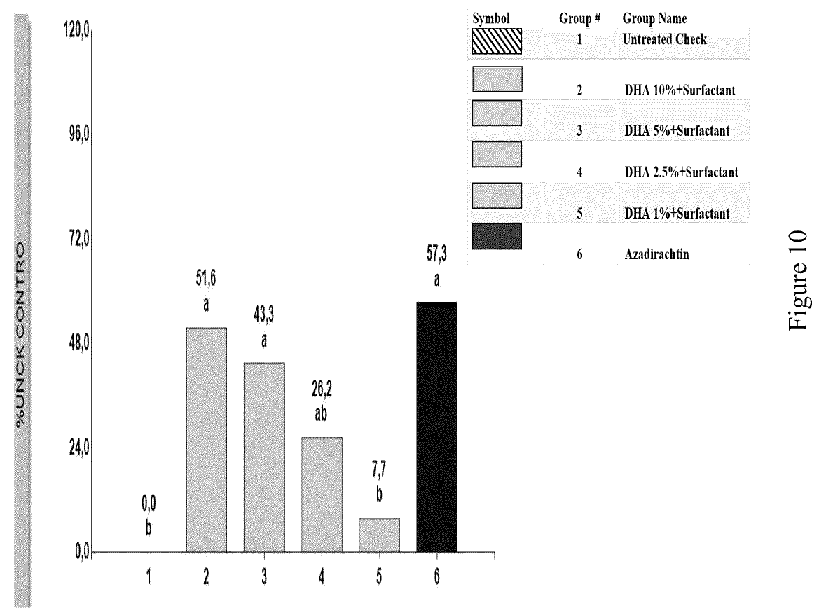

Efficacy percentage %, Day 14 following Third application of treatments (14 DA-C; FIG. 10).

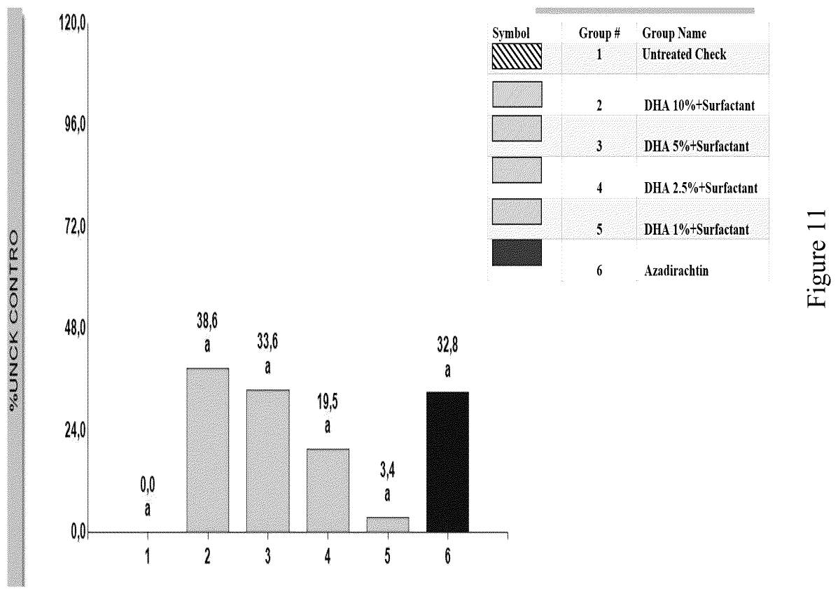

The last efficacy assessment (20 DA-C), performed on Day 21 following Third application of treatments 21 DA-C. The efficacy graph of Efficacy percentage % Day 21 following Third application of treatments 21 DA-C didn't show any statistically significant differences among the treatments. (21 DA-C; FIG. 11).

### Conclusions

During the trial, DHA formulations showed a decent dose effect. At 10%, 5% and 2.5% dose rates DHA formulations were comparable with Azadirachtin 26 g/L field rate; even at last assessment on day 21 (21 DA-C) DHA efficacy was statistically significant comparable in all tested doses with Azadirachtin.

Thus, DHA formulations showed an efficacy comparable with Azadirachtin until 20 days after the last treatment.

Azadirachtin showed expected results as a repellent, antifeeding and an action similar to a growth regulator compound, similarly to DHA formulations, which shows a repellent action too.

No phytotoxicity symptoms were observed during all trial period.

### Example 13

### Objectives

Assessment of Dihydroxyacetone product (DHA) for the control of Thrips tabaci in cabbage. Checking the safety of the material to the crop with and without surfactants adding.

### Materials and Methods

Variety—Procator
Plants per Hectar—45,000
Growing method: plants per hectare, 4 rows of planting on a 1.7 m width bed with drip irrigation.
Plant stage at first application: 4-6 leaves.
Sprayer: Solo back air blower (solution go out by gravitation) The experiment implemented with 4 replicates for each treatment (randomly spread). Each replicate was 8 m long, on one bed. Spraying volume was 270 L/hectare on the first application and 400 l/Hec on the second application.

### Treatments

DHA 2.5%, aqueous
DHA 5%, aqueous
DHA, 10%, aqueous
DHA 5%+Alkylaryl polyether alcohol (APA 0.2%)
Commercial formulation—Spinetoram 60 g/l 0.8 L per Hectar (Corteva)+Alkyl Phenol Oxide 920 g/l (surfactant|) 0.1%
Control (sprayed water)

Application dates: T1, T2 (6 days post T1) and T3—7 days post T2 in order to assess the efficacy of higher rates of surfactants.

Evaluation dates: one day before T1 (preliminary evaluation), insect immediate toxic effect assessment (T1+2 days), second evaluation at T1+6, third evaluation at T1+11, T2+4), and forth evaluation T1+16, T2+10)

On T3 there was a mini test to check safety of higher concentration of surfactants and the improvement of spreading. The plants visually checked to see the spread of the solution on the leaf.

Evaluations and statistics: Counting number of adult thrips and larva's separately on the on 10 leaves, selected randomly in each replicate. The leaves chosen are same on the size. Variance analysis was made by Tukey-Kramer (α=0.05).

### Results

TABLE 15
Average no. of adult Thrips per leaf.

| | preliminary | | | T1 + 11, | T1 + 16 |
|---|---|---|---|---|---|
| Treatment | evaluation | T1 + 2 | T1 + 6 | T2 + 4 | T2 + 10 |
| DHA 10% | 8.55 ^{a} | 34.475^{ab} | 50.45^{b} | 34.05 ^{bc} | 14.525 ^{cd} |
| DHA 5% | 8.325 ^{a} | 38.3 ^{a} | 56.05 ^{b} | 41.225 ^{b} | 20.7 ^{bc} |
| DHA 2.5% | 8.225 ^{a} | 42.3 ^{a} | 68.8 ^{a} | 52.875 ^{a} | 25.725 ^{ab} |
| DHA 5% + | 8.375 ^{a} | 26.025 ^{bc} | 36.6 ^{c} | 32.975 ^{bc} | 16.275 ^{bc} |
| APA 0.2% | | | | | |
| Commercial | 8.075 ^{a} | 18.45 ^{c} | 29.15 ^{c} | 26.2 ^{c} | 5.025 ^{d} |
| Formulation | | | | | |
| Control | 8.375 ^{a} | 41.675 ^{a} | 75.675 ^{a} | 58.25 ^{a} | 31.325 ^{a} |

Values with no letters (a, b, c) nor similar letter in a column are not significantly different (Tukey-Kramer; α = 0.05).

TABLE 16
Percentage of Cabage developing (%)

| | | | T1 + 11, | T1 + 16 |
|---|---|---|---|---|
| Treatment | T1 + 2 | T1 + 6 | T2 + 4 | T2 + 10 |
| DHA 10% | 100 | 100 | 95 | 85 |
| DHA 5% | 100 | 100 | 93.75 | 85 |
| DHA 2.5% | 100 | 100 | 93 | 81.25 |
| DHA 5% + | 100 | 100 | 100 | 95 |
| APA 0.2% | | | | |
| Commercial | 100 | 100 | 100 | 98.75 |
| Formulation | | | | |
| Control | 100 | 100 | 91.75 | 76.2 |

TABLE 17
Safety test. Burns, spots, phytotoxicity

| | | | T1 + 11, | T1 + 16 |
|---|---|---|---|---|
| Treatment | T1 + 2 | T1 + 6 | T2 + 4 | T2 + 10 |
| DHA 10% | 0 | 0 | 0 | 0 |
| DHA 5% | 0 | 0 | 0 | 0 |
| DHA 2.5% | 0 | 0 | 0 | 0 |
| DHA 5% + | 0 | 0 | 0 | 0 |
| APA 0.2% | | | | |
| Commercial | 0 | 0 | 0 | 0 |
| Formulation | | | | |
| Control | 0 | 0 | 0 | 0 |

### Summary and Discussion

### Formulation:

When DHA was sprayed without any surfactant it created round drops and rolled over the cabbage leaf, this resulted in low efficacy. Adding surfactant like Alkyl aryl polyether alcohol (APA—as a surfactant and as a pH buffer) improved the spread of the material on the leaf and improves efficacy, Visual tests showed that this formulation improves attachment with the crop surface.

The Effect on Adult T. abaci in Cabbage:

DHA 10%, 5%, and 2.5% have no insect immediate toxic effect.

The addition of Alkylaryl polyether alcohol (APA) resulted in an effect which was statistically significant and inferior to Spinetoram.

On T1+6 (6 days after first spraying) all DHA treatments showed better results compared to control except 2.5% treatment.

T1+11, T2+4 evaluation showed efficacy on adult Thrips, better than control and inferior to chemical treatment. It seems that it takes time until the maximum effect is achieved.

### Example 14

DHA can be used in concentrations of 0.1-20%, in combination with a pH stabilizer or buffer, or a surfactant/emulsifier or oils, or in combination with additional plant based and EPA (Environment Protection Agency)-approved pesticides. Such pesticides include azadirachtin, pyrethrins, Neem oil, mineral oil and fatty acid potassium salts (as powder or as liquid oil). These additional pesticides are used in concentrations of 0.01%-1.0%.

In another preferred embodiment of this invention, DHA (in concentration of 0.1-20%, final active concentration) is shown to have repellent efficacy, in this formulation:
DHA concentration up to 5%, preferably up to 2%
pH stabilizer or buffer such as citric acid buffer
Oils—such as mineral oil, silicone oil
A surfactant/emulsifier: emulsifiers improve stability, adherence and distribution on plant treatment.

Surfactants approved for agriculture such as Span 80, Tween 20, Tween 80, Triton and PEG-400, mostly non-ionic surfactants, inter alia:

Nonylphenol Ethoxylate (NPE)—Commonly used in herbicide formulations to enhance wetting and penetration.

Octylphenol Ethoxylate—Another widely used surfactant for pesticide formulations.

Alkyl Polyglucoside (APG)—A biodegradable surfactant derived from sugars and used in organic farming.

Polyethylene Glycol (PEG 400)—Often used as a carrier in pesticide formulations to improve distribution.

Span 80 (Sorbitan Monooleate)—Used in emulsions and pesticide formulations to improve adherence and stability.

Tween 20 (Polysorbate 20)—Commonly used as an emulsifier in agricultural sprays to improve coverage on plants.

Tween 80 (Polysorbate 80)—An effective emulsifier, suitable for use as an inert ingredient in combination with permitted active pesticidal ingredients

Alkylaryl polyether alcohol—Alkylaryl polyether alcohol polymers are known and used commercially as surface active detergents and wetting agents

These materials are specifically chosen for their ability to enhance the performance of agricultural chemicals by improving their spread, adhesion, and penetration into plants.

### Example 15

In another preferred embodiment of this invention, DHA will be mixed with surfactant and stabilizer (as liquid or as powder to be suspended) and diluted in water before the agricultural spraying. Additionally, the DHA product can be administered in the irrigation water.

1. An insect repellent composition for repelling insects from mammals and plants, comprising:
Dihydroxyacetone (DHA); and
a carrier suitable for insect repellent compositions,
wherein DHA is the active ingredient.

2. The composition of claim 1, formulated for application on plants, trees, or any part of plant or tree, selected from the group consisting of leaves, stalks, flowers, petals, tree trunks, fruits and any combination thereof.

3. The composition of claim 1 wherein said insect repellent composition is formulated for repelling insects from at least one plant selected from the group consisting of: tobacco, cannabis, or organically grown fruits and vegetables for human or animal consumption.

4. The composition of claim 1, wherein the concentration of DHA is in the range of 0.1% to 20% (% wt)

5. The composition of claim 1, wherein said composition is in a form selected from the group consisting of powder, liquid, aerosol, lotion, cream, gel, foam, shampoo, solid and any combination thereof.

6. The composition of claim 1, wherein said composition is in a spray form.

7. The composition of claim 1, wherein said composition is suitable for topical use or for spatial use.

8. The composition of claim 1, wherein said insects comprise at least one selected from the group consisting of: mosquitos, fleas, ants, sand flies, spiders, aphids, tobacco moths, head-lice, leaf aphid, bed bugs, whitefly, thrips and mites.

9. The composition of claim 1, wherein said composition additionally comprises at least one substance selected from the group consisting of water, ethanol, emulsifiers, preservatives, emollients, humectants, oils, surfactants, waxes, solvents, rheology modifiers, suspending agents, thickeners, oils, buffering agents, chelating agents, pH adjusters, chelates, perfumes, brighteners, and any combination thereof.

10. The composition of claim 9, wherein said composition comprises an emulsifier or surfactant comprising at least one compound selected from the group consisting of Nonylphenol Ethoxylate (NPE), Octylphenol Ethoxylate, Alkyl Polyglucoside (APG), Polyethylene Glycol (PEG 400), Span 80 (Sorbitan Monooleate), Tween 20 (Polysorbate 20), Tween 80 (Polysorbate 80), Alkylaryl polyether alcohol, and any combination thereof.

11. The composition of claim 9, wherein said composition comprises at least one oil selected from the group consisting of mineral oil and silicone oil.

12. The composition of claim 1, wherein said composition is formulated for immediate release, slow release, or a combination thereof.

13. The composition of claim 13, wherein said composition is in a formulation for slow release, and said slow-release formulation comprises DHA incorporated in at least one form selected from the group consisting of DHA incorporated in a polymeric matrix, micro-encapsulated of DHA, DHA incorporated into liposomes, DHA incorporated into granules, and any combination thereof.

14. The composition of claim 1, further comprising at least one plant-based insecticide, selected from the group consisting of Aloe Vera, tea tree essential oil, peppermint extract, apple cider vinegar, neem oil, tea tree oil, sesame oil, vegetable oil, menthol, geraniol, thyme oil, lemongrass oil, rosemary oil, jasmine oil, citronella extract, and any combination thereof.

15. The composition of claim 1, further comprising at least one additional pesticide, selected from the group consisting of azadirachin, pyrethrins, fatty acid potassium salts, sulfor, acetamiprid, spirotetramat, spinosad, and any combination thereof.

16. A method of repelling insects, comprising:
obtaining the composition of claim 1, and
applying said composition to a subject, thereby repelling insects.

17. A kit for dispensing an insect repellent composition, said kit comprising
a vaporizer,
the composition of claim 1.

18. The kit of claim 17, wherein said composition is liquid, semi solid or solid.

19. The kit of claim 17, wherein the vaporizer comprises at least one device selected from the group consisting of a plug-in electrical device, a spraying device, and a coil.
